(19) United States
(12) Patent Application Publication
(10) Pub. No.: US 2017/0185923 A1
(43) Pub. Date: Jun. 29, 2017

(54) EXERCISE APPARATUS GROUP

(71) Applicant: Cheng Kun Lee, Taichung (TW)

(72) Inventor: Cheng Kun Lee, Taichung (TW)

(73) Assignee: Johnson Health Tech. Co., Ltd.

(21) Appl. No.: 14/983,336

(22) Filed: Dec. 29, 2015

(51) Int. Cl. G06Q 10/02; A63B 24/00

(52) U.S. Cl. CPC G06Q 10/02; A63B 24/0087

(57) ABSTRACT

An exercise apparatus group comprises exercise apparatuses, an interconnecting member and a booking server. The interconnecting member receives a location identifier from a portable device of a user to determine a location of the user. Thereafter, the interconnecting member transmits location information to the booking server. Simultaneously, the user accesses the booking server to book a time segment for one exercise apparatus, via the portable device thereof. Finally, the booking server transmits a feedback, which having information on the current location thereof relative to the exercise apparatus, to the portable device of the user. Therefore, the user would know how to go the exercise apparatus.

### BACKGROUND

1. Field of the Invention

The present disclosure relates to an exercise apparatus. More particularly, the present disclosure relates to an exercise apparatus group.

2. Description of the Related Art

Recently, people who must sit at a desk and work during the day, are becoming more aware of their own physical fitness and the need to exercise. New gyms (or the other types of workout facility) are being opened every day to provide a place where the people can go to use various kinds of exercise apparatuses. Then, here comes one problem which makes the workouts of the user difficult to schedule and carry out. Clearly, each gym has a variety of exercise apparatuses such as treadmills, cycles, climbmills and weight training apparatus. Each of these types may be considered as a workout station. When the user schedules his (or her) workout, the user should be certain that the proper types of exercise apparatuses are available at the workout time. However, more often than not the user cannot achieve the workout and measure his (or her) accomplishments because when the user is ready to exercise with a certain exercise apparatus, this exercise apparatus is being used by another user of the gym. In order to overcome the issue, a conventional exercise apparatus group (such as the embodiment disclosed in U.S. Pat. No. 6,050,924) comes to the world.

U.S. Pat. No. 6,050,924 discloses that each exercise apparatus of a gym has a console. The console is associated with a gym server of the gym. A user can book the next exercise apparatus via accessing the gym server by the console of the current exercise apparatus which is being used by the user. Specially, the booking may be for a particular time segment, e.g., 6:30 p.m. to 7:00 p.m., for a particular exercise apparatus when it becomes free, or for any exercise apparatus of a particular workout station when it becomes free. When the booked exercise apparatus becomes free or when the particular time segment starts, the user is provided with a prompt at the current exercise apparatus at which he (or she) is currently exercising. The prompt may be either visual (e.g., on the display of the exercise terminal) or aural (e.g., from the speaker of the exercise apparatus). The booked exercise apparatus is then available only for the user's use for a buffer period of time, e.g., five minutes. During the buffer period, other users will be locked-out from using the exercise apparatus. The exercise apparatus can be used only by entering the identifier or some password of the user who booked the exercise terminal. In addition, if the user doesn't go to use the booked exercise apparatus in the buffer period, the booking will be canceled. However, the user can only book the next exercise apparatus at the workout space of the current exercise apparatus which is being used by the user, because the console is combined with the body of each exercise apparatus.

U.S. Pat. No. 8,128,532 discloses that one user of a gym has a portable device, such as a smart phone or personal digital assistant device (PDA). Booking software, such as mobile app, can be installed on the portable device. When the user opens the booking software on his (or her) portable device, the portable device is, via wireless networking capabilities, associated with a gym server and enabled to transmit signals thereto and receive signals therefrom. The signals are used for booking the next exercise apparatus of the gym. Therefore, the user can carry out the booking processing at any space of the gym. Unfortunately, after provided with a prompt, the user often goes to the next exercise apparatus via a detoured, because he (or she) has no sense of the layout of the gym. As a result, the booking will probably be canceled, because the user is delayed by the detour and too late to arrive at the booked exercise apparatus in the buffer period.

The present invention has arisen to mitigate and/or obviate the disadvantages of the conventional method of building an exercise program. Further benefits and advantages of the present invention will become apparent after a careful reading of the detailed description with appropriate reference to the accompanying drawings.

### SUMMARY

The present invention involves an exercise apparatus group. Generally speaking, the exercise apparatus group is to provide a booking service for a user. Specially, the user can get information on the current location thereof relative to the booked exercise apparatus.

According to one aspect of the present invention, the exercise apparatus group includes exercise apparatuses, an interconnecting member and a booking server. Each of the exercise apparatuses has an exercise unit and an electronic circuit unit associating the exercise unit. The electronic circuit unit is configured to create a status signal representing a status of the exercise unit. The interconnecting member is set in the workout facility to communicate with the electronic circuit unit of each of the exercise apparatuses and a portable device of a user in the workout facility respectively via a first connection and a second connection. The portable device is configured to receive a booking command from the user. The booking command is converted into a booking signal by the portable device. The interconnecting member is configured to receive the status signal from the electronic circuit unit via the first connection, receive the booking signal from the portable device via the second connection and receive a location identifier from the portable device to determine a location of the user in the workout facility. The booking server communicates with the interconnecting member via a third connection. The location identifier is converted into a location information signal by the interconnecting member. The location information signal, the status signal and the booking signal are transmitted from the interconnecting member to the booking server via the third connection. Specially, the booking server is configured to create a feedback signal according to the status signal, the booking signal and the location information signal. The feedback signal is transmitted from the booking server to the portable device via the third connection and the second connection. The booking server is configured to create a request signal. The request signal is transmitted from the booking server to the electronic circuit unit of at least one of the exercise apparatuses via the third connection and the first connection.

According to another aspect of the present invention, the portable device converts the feedback signal into a media content. The media content comprises a user location icon representing a current location of the user in the workout facility.

According to another aspect of the present invention, the media content further comprises a guidance icon representing a route from the current location of the user to a fixed location of the at least one of the exercise apparatuses.

According to another aspect of the present invention, the media content further comprises a walking time icon representing a walking time for walking to the at least one of the exercise apparatuses on the route.

According to another aspect of the present invention, the media content further comprises a notice icon to notice the user, the notice icon provided upon the walking time.

According to another aspect of the present invention, the request signal is created according to the status signal, the booking signal and the location information signal.

According to another aspect of the present invention, an exercise apparatus group includes exercise apparatuses, an interconnecting member and a booking server. Each exercise apparatus has an exercise unit and an electronic circuit unit associating the exercise unit. The electronic circuit unit is configured to create a status signal representing a status of the exercise unit. The interconnecting member is configured to receive a location identifier from a portable device of a user in the workout facility to determine a location of the user in the workout facility and receive the status signal from the electronic circuit unit via a first connection. The booking server communicates with the portable device and the interconnecting member respectively via a second connection and a third connection. The portable device is configured to receive a booking command from the user. The booking command is converted into a booking signal by the portable device. The booking signal is transmitted from the portable device to the booking server via the second connection. The location identifier is converted into a location information signal by the interconnecting member. The location information signal and the status signal are transmitted from the interconnecting member to the booking server via the third connection. Wherein the booking server is configured to create a feedback signal according to the status signal, the booking signal and the location information signal. The feedback signal is transmitted from the booking server to the portable device via the second connection.

There are several advantages of a basic embodiment of the present invention. The user will not be delayed by the detour any more. Moreover, the user also will arrive at the booked exercise apparatus exactly on time, because the booking server transmits the further feedback signal to the portable device exactly the walking time before the booked time segment.

The reader is advised that this summary is not meant to be exhaustive. Further features, aspects, and advantages of the present invention will become better understood with reference to the following description, accompanying drawings and appended claims.

Further benefits and advantages of the present invention will become apparent after a careful reading of the detailed description with appropriate reference to the accompanying drawings.

### BRIEF DESCRIPTION OF THE DRAWINGS

FIG. 1 is a schematic view of a first embodiment of the present invention;

FIGS. 2-5 are illustrative views for showing media contents for booking of the present invention;

FIG. 6 is a illustrative view for showing a media content for notice of the present invention;

FIGS. 7-8 are illustrative views for showing media contents for multi-booking of the present invention;

FIG. 9 is a illustrative view for showing a media content for guidance of the present invention; and

FIG. 10 is a schematic view of a second embodiment of the present invention.

### DETAIL DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically depicted in order to simplify the drawings.

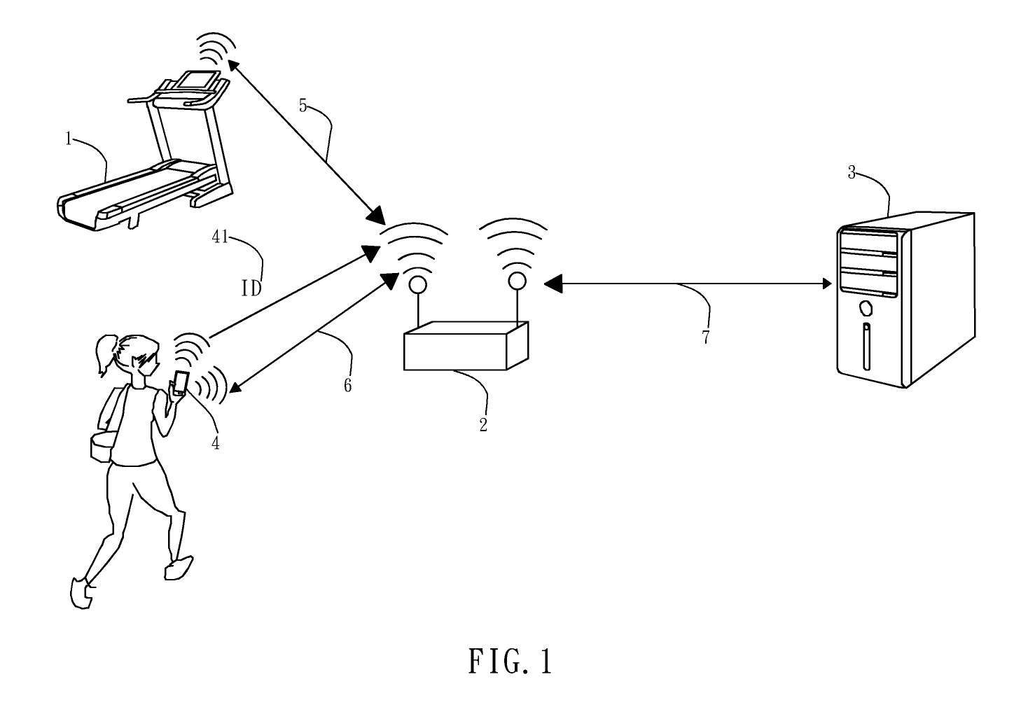

Referring to FIG. 1, according to a first embodiment of the present invention, an exercise apparatus group is described as follows. The exercise apparatus group comprises a plurality of exercise apparatuses 1, an interconnecting member 2 and a booking server 3. The exercise apparatuses 1, the interconnecting member 2 and the booking server 3 are all set in a workout facility. In another embodiment, only the booking server might be set at a certain site out of the workout facility. Each exercise apparatus 1 has an exercise unit and an electronic circuit unit (not shown) associating the exercise unit. The electronic circuit unit is substantially illustrated as a hardware, software and firmware assembly which is configured to process each signal according to each corresponding command. For example, the electronic circuit unit has a microcontroller unit, at least one electronic circuit and at least one circuit board. A certain program is read in the microcontroller unit. The microcontroller unit and the electronic circuit are assembled on the circuit board so as to define an assembly as a whole. In addition, the assembly is associated with another one, or an electric device via a wired connection (such as bus wire) or a wireless connection (such as Bluetooth or Wi-Fi). The electronic circuit unit is configured to create a status signal which represents a status of the exercise unit. The status of the exercise unit means whether there is a user operating the exercise unit, the identity of the user, and the availability of the exercise unit.

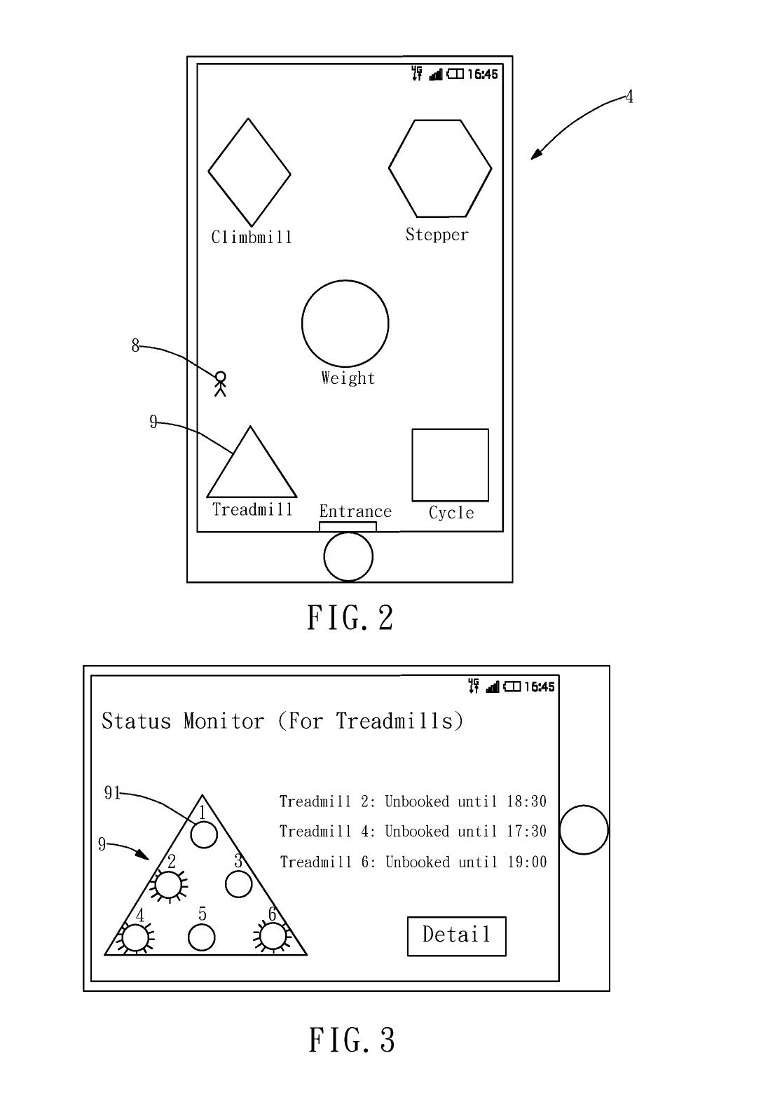

The interconnecting member 2 is set at a certain site of the workout facility. The interconnecting member 2 communicates with the electronic circuit unit of each exercise apparatus 1 and a portable device 4 of the user in the workout facility respectively via a local connection 5 and a local wireless connection 6, which both cover a limited area such as a residence, school, laboratory, office building, or gym club. The local connection 5 might be illustrated as a wired connection (such as bus wire or cable) or a wireless connection (such as Bluetooth or Wi-Fi). The local wireless connection 6 is illustrated as a type of wireless connection, such as Bluetooth or Wi-Fi. The interconnecting member 2 is configured to receive the status signal from the electronic circuit unit of each exercise apparatus 1, via the local connection 5. A kind of software, such as a mobile app, is installed on the portable device 4. When the user opens the mobile app on the portable device 4, the local wireless connection 6 is built between the portable device 4 and the interconnecting member 2 and a user control interface of the portable device 4 is enabled to receive a booking command from the user. Clearly, the user control interface might be illustrated as a touch-screen (as shown in FIGS. 2-9). The user could manipulate the user control interface, so as to create the booking command. If the user control interface receives the booking command, the booking command is transmitted to an electronic circuit unit (not shown) of the portable device 4 (The electronic circuit unit is substantially the same as that of the exercise apparatus 1). Thereafter, the electronic circuit unit converts the booking command into a booking signal for the purpose of the booking command (the detail of the converting is well-known and will not be further described herein.). The interconnecting member 2 is configured to receive the booking signal from the portable device 4 via the local wireless connection 6. Simultaneously, the portable device 4 continuously broadcasts a location identifier 41. In this embodiment, the location identifier 41 is illustrated as certain identifier utilizing Bluetooth Low Energy (BLE) protocol, such as iBeacon identifier. However, these components shouldn't limit the present invention; in other words, the location identifier might be something other than an iBeacon identifier. For instance, it could be another type of identifier, such as a RF (Radio-frequency) identifier or NFC (Near Field Communication) identifier, under the present invention. The location identifier 41 broadcasted from the portable device 4 is unique to the portable device 4 of the user, and then represents a location information of the portable device 4 relative to a certain object receiving the location identifier 41 in the workout facility. The location information might be how far it is between the interconnecting member 2 and the certain object and what direction it is from the interconnecting member 2 to the certain object. As a result, the location of the user in the workout facility could be determined (The detail of the indoor positioning system is well-known and will not be further described here). The interconnecting member 2 is configured to receive the location identifier 41 from the portable device 4 via the broadcast, so as to determine the location of the user in the workout facility. In other embodiments, the location identifier 41 might be transmitted from the portable device 4 to the interconnecting member 2 via certain path other than a broadcast. For instance, the location identifier 41 might be transmitted from the portable device 4 to the interconnecting member 2 via the local wireless connection 6.

The booking server 3 is substantially illustrated as a computer that can be programmed to carry out a set of arithmetic or logical operations automatically. The booking server 3 communicates with the interconnecting member 2 via a network connection 7. The network connection 7 might be illustrated as a LAN (Local Area Network) connection such as Bluetooth, Wi-Fi or local cable, or a WAN (Wide Area Network) connection such as LTE, WiMAX or leased line. If the network connection 7 is illustrated as a LAN connection, the booking server 3 is set in a workout facility. In addition, the interconnecting member 2 might be integrated into the booking server 3. If the network connection 7 is illustrated as a WAN connection, the booking server 3 is set at a certain site out of the workout facility. In this way, the booking server 3 can communicate with a plurality of interconnecting members of different workout facilities. The interconnecting member 2 converts the location identifier 41 into a location information signal (the detail of the converting is well-known and will not be further described herein.). The interconnecting member 2 transmits the location information signal, the status signal and the booking signal to the booking server 3 via the network connection 7. Thereafter, the booking server 3 creates at least one feedback signal according to the status signal, the booking signal and the location information signal. Finally, the booking server 3 transmits the feedback signal to the portable device 4 via the network connection 7 and the local wireless connection 6. The electronic circuit unit of the portable device 4 converts the feedback signal into a media content. The media content is illustrated as an image content, a sound content or the combination thereof. The media content is provided for the user via the user control interface of the portable device 4. In addition, the booking server 3 creates a request signal according to the status signal, the booking signal and the location information signal. The booking server 3 transmits the request signal to the electronic circuit unit of at least one of the exercise apparatuses 1 via the network connection 7 and the local connection 5. The electronic circuit unit converts the request signal into an order for the exercise unit of the exercise apparatuses 1.

Under this arrangement, when the user enters the workout facility, the user can open the mobile app on his (or her) portable device 4. Then, the local wireless connection 6 is built between the portable device 4 and the interconnecting member 2 in the workout facility, and the user logs in to the booking server 3 via the local wireless connection 6 and the network connection 7. As a result, the user control interface of the portable device 4 is manipulable for the user (as shown in FIGS. 2-9).

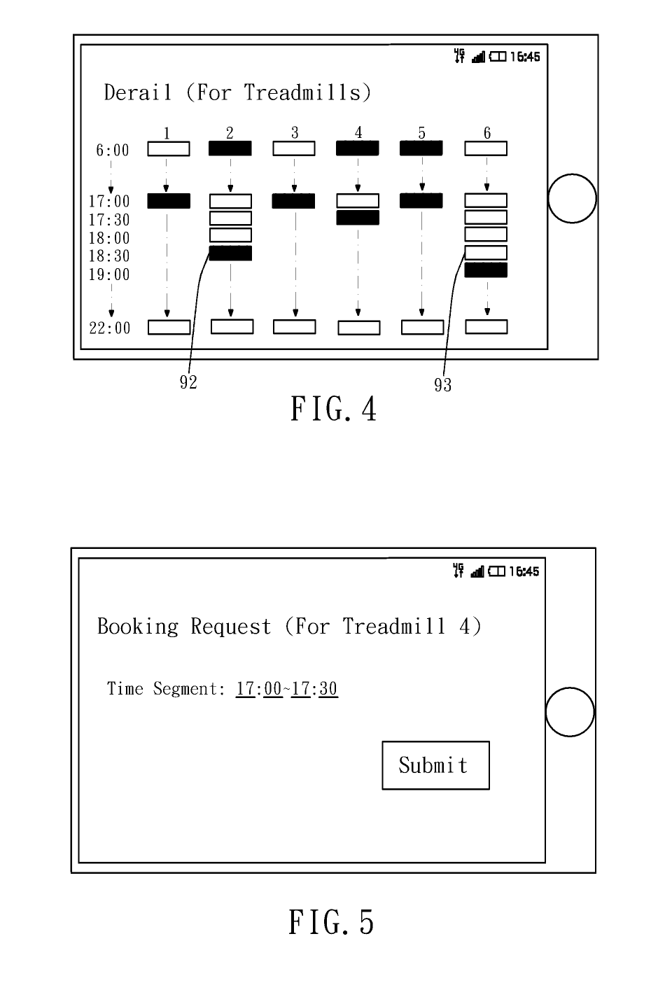

Referring to FIGS. 2-6, the user control interface of the portable device 4 shows a layout content to the user (at 16:45). The layout content comprises a user location icon 8 and a plurality of workout station icons such as a treadmill station icon 9. The user location icon 8 represents a current location of the user in the workout facility, and the workout station icons represent fixed locations of the workout stations. As a result, the user can understand his (or her) current location relative to the workout stations. Therefore, the layout content is substantially similar to a map of a navigator device. When the user wants to use, in a certain time segment, the exercise apparatus of one workout station, the treadmill station for example, the user just touches the treadmill station icon 9. Then, the user control interface of the portable device 4 shows a status monitor content to the user (as shown in FIG. 3). Referring to FIG. 3, the status monitor content comprises information on the status of the treadmill station, such as a plurality of individual treadmill icons 91 of the treadmill station icon 9. The second, fourth and sixth individual treadmill icons 91 are shining. It means that the next time segment (17:00˜17:30) for each of the second, fourth and sixth individual treadmills is bookable. Clearly, the booking condition is that there is no other user who books the next time segment for the second, fourth or sixth individual treadmill, and other user being using the second, fourth or sixth individual treadmill must have booked a time segment in which the finish moment is 17:00 or there is no user being using the second, fourth or sixth individual treadmill. The status monitor content also comprises brief information on the bookable individual treadmills, such as how late each of the bookable individual treadmills is unbooked. If the user wants to know detail information on the bookable individual treadmills or the other individual treadmills, the user can touch the “Detail” key to get an individual detail content (as shown in FIG. 4). Referring to FIG. 4, the individual detail content comprises a plurality of time segment icons for each of the individual treadmills. The time segment icons are arranged in order upon the timeline. The time segments that have already been booked by other users are shown as filled (or blackened) time segment icons 92. The time segments that have not yet been booked by other users are shown as emptied (or whiten) time segment icons 93. The user can touch one emptied time segment icon 93, for the fourth individual treadmill for example, to get a booking request content (as shown in FIG. 5). Referring to FIG. 5, the booking request content comprises desired time segment information, in which the user can edit the desired time segment. When the user confirms the desired time segment, then the user can touch the “Submit” key to drive the portable device 4 to transmit a booking signal to the booking server 3. If the status of the desired exercise apparatus does not satisfy the booking condition, the booking server 3 will not transmit, even create, any request signal to the desired exercise apparatus, but will transmit a feedback signal to the portable device 4 to provide a rejection content, comprising a rejection prompt (not shown), for the user. In contrast, if the status of the desired exercise apparatus satisfies the booking condition, the booking server 3 will transmit a request signal to the desired exercise apparatus, and will transmit a feedback signal to the portable device 4 to provide an acceptance content, comprising an acceptance prompt (not shown), for the user. The request signal is converted into an order, such as being available only for the user's use during the booked time segment, for the exercise unit of the exercise apparatuses 1 (the booking sequence is well-known and will not be further described herein). Referring to FIG. 6, when the booked time segment starts, the booking server 3 will transmit a further feedback signal to the portable device 4 to provide a notice content. Compared to the layout content, the notice content further comprises a notice icon 81, a guidance icon 82 and a walking time icon 83. The notice icon 81 might be illustrated as a visual prompt, such as “Your Turn!”. Specially, the guidance icon 82 is substantially located between the user location icon 8 and the fourth individual treadmill icon 91, and represents a shortest route from the current location of the user to the fourth individual treadmill in the workout facility. In this way, the user can go to the booked individual treadmill on the shortest route by the guidance icon 82. In addition, the walking time icon 83 represents a walking time, fine minutes for example, for walking to the booked individual treadmill on the shortest route. Particularly, the notice icon 81 is provided for the user, exactly the walking time before the booked time segment. Therefore, the user will not be delayed by the detour any more. Moreover, the user also will arrive at the booked exercise apparatus exactly on time, because the booking server 3 transmits the further feedback signal to the portable device 4 exactly the walking time before the booked time segment.

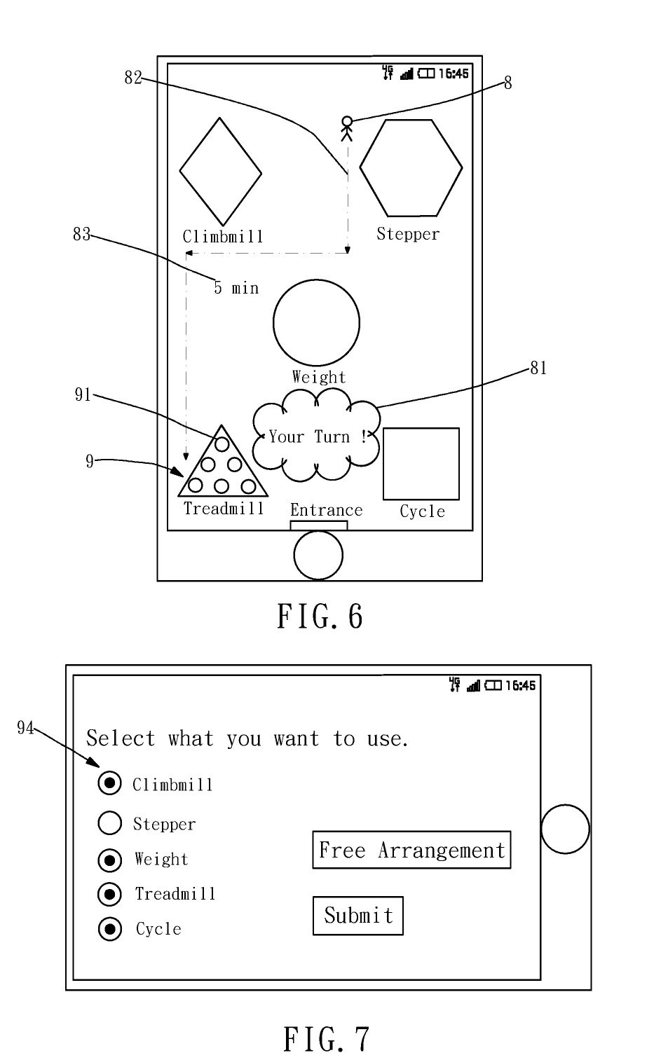

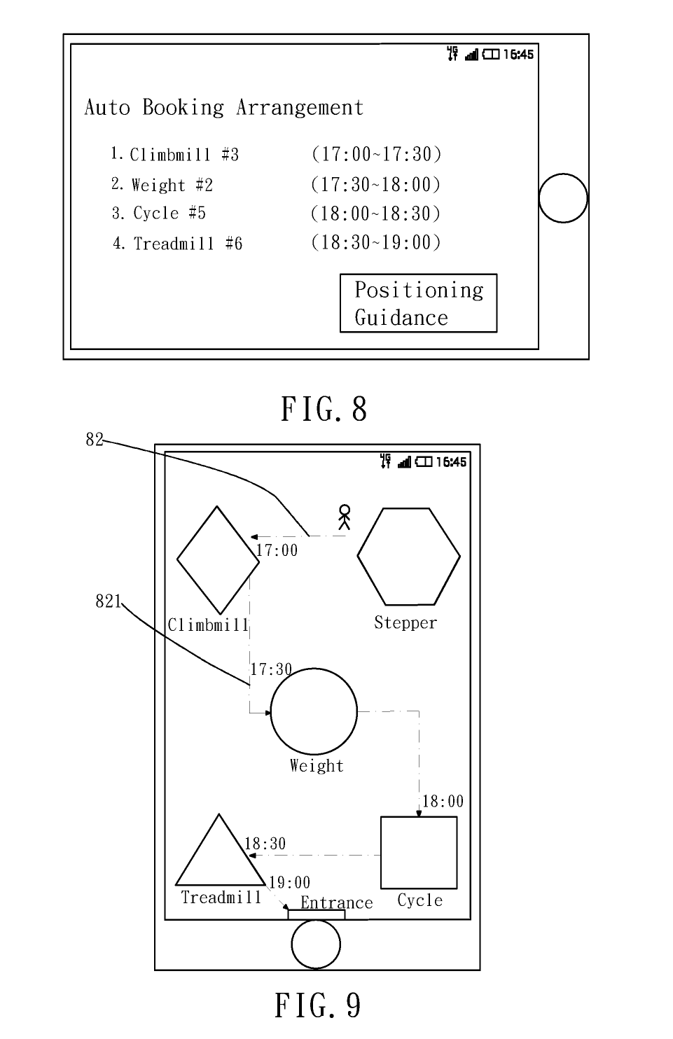

Referring to FIGS. 7-9, the user can manipulate the user control interface of the portable device 4 to get a multi-booking content (as shown in FIG. 7). Referring to FIG. 7, the multi-booking content comprises several option icons 94 respectively representing several exercise apparatus types. When the user wants to use climbmill, weight, treadmill and cycle, the user can click on the option icons 94 respectively representing climbmill, weight, treadmill and cycle. Then, the user touches the “Submit” key to drive the portable device 4 to transmit a booking signal to the booking server 3. Thereafter, the booking server 3 will transmit a request signal to each of the mentioned exercise apparatuses and the user gets an arrangement content (as shown in FIG. 8) on his (or her) portable device 4, if the booking condition is satisfied. Referring to FIG. 8, the arrangement content shows arrangement information, such as a sequence of the booked time segments respectively for the mentioned exercise apparatuses, the detail of each of the booked time segments, and which one mentioned exercise apparatus to use. Specially, the sequence is defined according to the current location of the user, clearly, the distance between the user and each of the mentioned exercise apparatus. For example, if the treadmill station is the closet to the user, the booked time segment for one treadmill of the treadmill station is the first in the sequence for the user to use. If the user does not know the layout of the workout facility, the user can touch the “Positioning Guidance” key to get a guidance content (as shown in FIG. 9). Referring to FIG. 9, compared to the notice content, the guidance content further comprises a plurality of sub guidance icons 821. Each sub guidance icon 821 is substantially located between one workout station icon and the next one upon the sequence. The guidance content might also comprise some detail of each booked time segment, such as the beginning time of each booked time segment

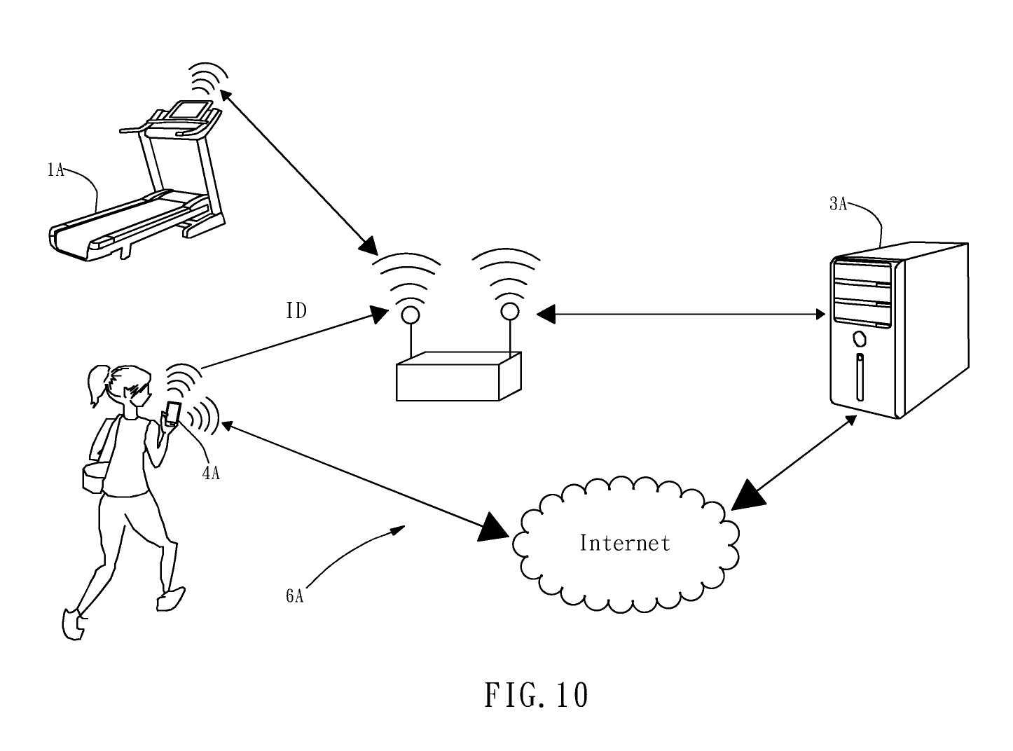

Referring to FIG. 10, a second embodiment of the present invention is described as follows. There are many similarities between the earlier embodiment and this second embodiment, so generally speaking, only the difference between the second embodiment and the first embodiment is further described. The local wireless connection is replaced with a wide wireless connection 6A. Clearly, the wide wireless connection 6A is built between a portable device 4A and a booking server 3A. The wide wireless connection 6A covers a larger geographic distance. The wide wireless connection 6A is illustrated as a type of wireless connection, such as LTE or WiMAX. Therefore, the booking signal and the feedback signal are both transmitted only via the wide wireless connection 6A. In this way, when the user is out of the workout facility, at home for example, and wants to book an exercise apparatus 1A, the user does not need to go to the workout facility and manipulate the portable device 4A for booking. In other words, the user can just manipulate the portable device 4A at home for booking.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An exercise apparatus group comprising:
exercise apparatuses set in a workout facility, each of the exercise apparatuses having an exercise unit and an electronic circuit unit associating the exercise unit, the electronic circuit unit configured to create a status signal representing a status of the exercise unit;
an interconnecting member set in the workout facility to communicate with the electronic circuit unit of each of the exercise apparatuses and a portable device of a user in the workout facility respectively via a first connection and a second connection, the portable device configured to receive a booking command from the user, the booking command converted into a booking signal by the portable device, the interconnecting member configured to receive the status signal from the electronic circuit unit via the first connection, receive the booking signal from the portable device via the second connection and receive a location identifier from the portable device to determine a location of the user in the workout facility; and
a booking server communicating with the interconnecting member via a third connection, the location identifier converted into a location information signal by the interconnecting member, the location information signal, the status signal and the booking signal transmitted from the interconnecting member to the booking server via the third connection, wherein the booking server is configured to create a feedback signal according to the status signal, the booking signal and the location information signal, the feedback signal transmitted from the booking server to the portable device via the third connection and the second connection, the booking server configured to create a request signal, the request signal transmitted from the booking server to the electronic circuit unit of at least one of the exercise apparatuses via the third connection and the first connection.

2. The exercise apparatus group as claimed in claim 1, wherein the portable device converts the feedback signal into a media content, the media content comprising a user location icon representing a current location of the user in the workout facility.

3. The exercise apparatus group as claimed in claim 2, wherein the media content further comprises a guidance icon representing a route from the current location of the user to a fixed location of the at least one of the exercise apparatuses.

4. The exercise apparatus group as claimed in claim 3, wherein the media content further comprises a walking time icon representing a walking time for walking to the at least one of the exercise apparatuses on the route.

5. The exercise apparatus group as claimed in claim 4, wherein the media content further comprises a notice icon to notice the user, the notice icon provided upon the walking time.

6. The exercise apparatus group as claimed in claim 1, wherein the request signal is created according to the status signal, the booking signal and the location information signal.

7. An exercise apparatus group comprising:
exercise apparatuses set in a workout facility, each of the exercise apparatuses having an exercise unit and an electronic circuit unit associating the exercise unit, the electronic circuit unit configured to create a status signal representing a status of the exercise unit;
an interconnecting member set in the workout facility, the interconnecting member configured to receive a location identifier from a portable device of a user in the workout facility to determine a location of the user in the workout facility and receive the status signal from the electronic circuit unit via a first connection; and
a booking server communicating with the portable device and the interconnecting member respectively via a second connection and a third connection, the portable device configured to receive a booking command from the user, the booking command converted into a booking signal by the portable device, the booking signal transmitted from the portable device to the booking server via the second connection, the location identifier converted into a location information signal by the interconnecting member, the location information signal and the status signal transmitted from the interconnecting member to the booking server via the third connection, wherein the booking server is configured to create a feedback signal according to the status signal, the booking signal and the location information signal, the feedback signal transmitted from the booking server to the portable device via the second connection.
